(19) United States
(12) Patent Application Publication
(10) Pub. No.: US 2024/0418819 A1
(43) Pub. Date: Dec. 19, 2024

(54) MACHINE LEARNING BASED POSITIONING

(71) Applicant: Apple Inc., Cupertino, CA (US)

(72) Inventors: Alexander SIROTKIN, Hod Hasharon (IL); Zhibin WU, Los Altos, CA (US); Haijing HU, Los Gatos, CA (US); Seyed Ali Akbar FAKOORIAN, San Diego, CA (US); Sudeep MANITHARA VAMANAN, Uttenreuth (DE)

(21) Appl. No.: 18/700,500

(22) PCT Filed: Oct. 12, 2022
(86) PCT No.: PCT/US2022/077972

§ 371 Date: Apr. 11, 2024

Related U.S. Application Data
(60) Provisional application No. 63/255,393, filed on Oct. 13, 2021.

(51) Int. Cl. G01S 5/02

(52) U.S. Cl. CPC G01S 5/0263; G01S 5/02521

(57) ABSTRACT

Disclosed are methods, systems, and computer-readable medium to perform operations including: receiving a plurality of position estimates for a user device; providing the plurality of position estimates as input to a trained machine learning model; and outputting a hybrid position of the user device.

### CROSS-REFERENCE TO RELATED APPLICATIONS

The present application claims priority to U.S. Prov. App. No. 63/255,393, filed on Oct. 13, 2021, entitled “Machine Learning Based Positioning.”

### BACKGROUND

Modern mobile devices (e.g., a smart phone, e-tablet, wearable devices) include a navigation system. The navigation system can include a microprocessor that executes a software navigation application that uses data from one or more inertial sensors (e.g., accelerometer, gyro, magnetometer) and position coordinates from a positioning system (e.g., satellite-based, network-based) to determine the current location and direction of travel of the mobile device. The navigation application allows a user to input a desired destination and calculate a route from the current location to the destination according to the user's preferences. A map display includes markers to show the current location of the mobile device, the desired destination and points of interest (POIs) along the route. Some navigation applications can provide a user with turn-by-turn directions. The directions can be presented to the user on the map display and/or by a navigation assistant through audio output. Other mobile device applications may use location for personalization and context.

### SUMMARY

This disclosure describes methods and systems for using machine-learning to improve the positioning accuracy of user devices. More specifically, this disclosure describes a hybrid positioning system and a user equipment (UE)-based fingerprinting system. As described in more detail below, these systems use machine-learning to improve the positioning accuracy of user devices, e.g., in a wireless communication system.

In accordance with one aspect of the present disclosure, a method involves receiving a plurality of position estimates for a user device; providing the plurality of position estimates as input to a trained machine learning model; and outputting a hybrid position of the user device.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, plurality of position estimates are generated from a plurality of positioning methods.

In some implementations hybrid position is a weighted average of the plurality of position estimates.

In some implementations, the machine learning model is trained using a machine learning algorithm. In some implementations, the machine learning algorithm is a supervised learning algorithm.

In some implementations, the machine learning training involves comparing an output of the machine learning model to reference location information. In some implementations, the reference location information is known location information.

In some implementations, the method is executed by the user device.

In some implementations, the method is executed by a network entity.

In some implementations, the network entity is an LMF.

In some implementations, the method further involves: receiving a first message from a network entity requesting the hybrid position, and generating a second message to communicate the hybrid position to the network entity.

In some implementations, the first message is a RequestLocationInformation message from the network, and the second message is a LPP ProvideLocationInformation message.

In some implementations, the method further involves: generating a request for the machine learning model; communicating the request in a first message to a training node, and receiving the machine learning model in a second message from the training node.

In some implementations, the first message is a LPP RequestAssistanceData message and the second message is a LPP ProvideAssistanceData message.

In some implementations, the first message is an LPP message RequestUEAssistanceData and the second message is an LPP ProvideUEAssistanceData message.

In accordance with another aspect of the present disclosure, a method involves receiving a map of radio frequency measurements; measuring a respective signal strength indicator value for one or more signals received by the user device; determining a position of the user device based on the respective signal strength indicator value for the one or more signals received by the user device.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, using the map to determine the position of the user device involves: comparing the respective signal strength indicator value to the map; and identifying k-nearest matches to the respective signal strength indicator value.

In some implementations, the comparison is performed using a K-nearest neighbor (KNN) algorithm.

In some implementations, identifying K-nearest matches involves using a Euclidean distance between the respective signal strength indicator value and one or more reference values in the map.

In some implementations, the method further involves calculating the position based on K-nearest fingerprints.

In some implementations, calculating the position based on the k-nearest fingerprints involves averaging positions associated with K-nearest matches.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### BRIEF DESCRIPTION OF THE FIGURES

FIG. 1 illustrates a wireless communication system, according to some implementations, according to some implementations.

FIG. 2 illustrates an example hybrid positioning system, according to some implementations.

FIG. 3 illustrates an example hybrid positioning workflow, according to some implementations, according to some implementations.

FIG. 4 illustrates a user device-based (UE-based) fingerprinting positioning system, according to some implementations.

FIG. 5A illustrates a hybrid positioning method, according to some implementations.

FIG. 5B illustrates a UE-based fingerprinting positioning method, according to some implementations.

FIG. 6 is a block diagram of an example device architecture, according to some implementations.

FIG. 7 illustrates an example of a wireless communication system, according to some implementations.

Like reference numbers and designations in the various drawings indicate like elements.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

This disclosure describes methods and systems for using machine-learning to improve the positioning accuracy of user devices. More specifically, this disclosure describes a hybrid positioning system and a user equipment (UE)-based fingerprinting system. As described in more detail below, these systems use machine-learning to improve the positioning accuracy of user devices, e.g., in a wireless communication system.

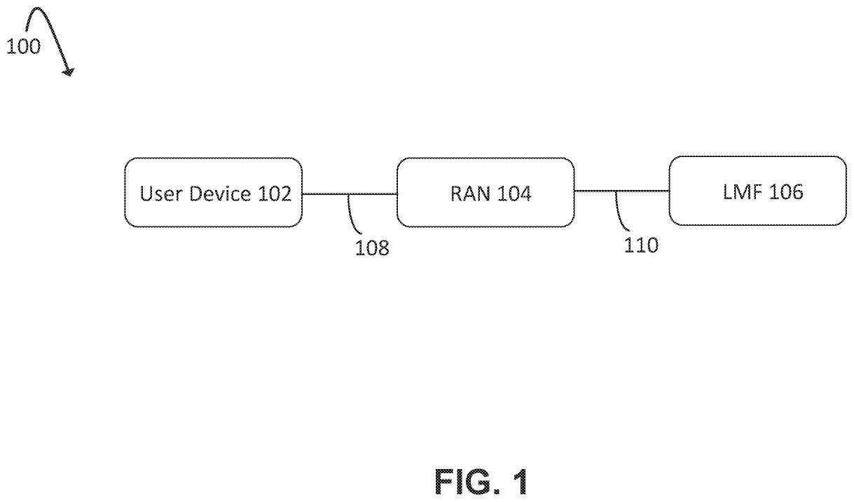

FIG. 1 illustrates a wireless communication system 100, according to some implementations. For purposes of convenience and without limitation, the example system 100 is described in the context of Long Term Evolution (LTE) and Fifth Generation (5G) New Radio (NR) communication standards as defined by the Third Generation Partnership Project (3GPP) technical specifications. More specifically, the wireless communication system 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 100 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like.

As shown in FIG. 1, the wireless communication system 100 includes a user device 102. The user device 102 can comprise any mobile or non-mobile computing device, such as consumer electronics devices, cellular phones, smartphones, feature phones, tablet computers, wearable computer devices, and/or the like.

The user device 102 may be configured to connect, for example, by communicatively coupling, with radio access network (RAN) 104. In embodiments, the RAN 104 may be an NG RAN or a 5G RAN, an E-UTRAN, or a legacy RAN, such as a UTRAN or GERAN. As used herein, the term “NG RAN” or the like may refer to a RAN that operates in an NR or 5G system, and the term “E-UTRAN” or the like may refer to a RAN that operates in an LTE or 4G system. The user device 102 utilizes connection (or channel) 108, which comprises a physical communications interface or layer.

In an example, the connection 108 is an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As also shown in FIG. 1, the wireless communication system 100 includes a Location Management Function (LMF) 106. The LMF 106 is a network entity in the 5G Core Network (5GC) that supports one or more of the following functionalities: (i) location determination for a user device (e.g., the user device 102), (ii) obtaining downlink location measurements or a location estimate from a user device (e.g., the user device 102), (iii) obtaining uplink location measurements from a RAN (e.g., RAN 104), (iv) obtaining non-UE associated assistance data from a RAN (e.g., RAN 104). Accordingly, the LMF 106 can receive information from the user device 102 and/or the RAN 104, and can use the information to calculate a position of the user device 102. The information can include measurements and assistance information. Although the LMF 106 is shown in FIG. 1 as being directly connected to the RAN 104 via connection 110, the LMF 106 may alternatively be indirectly connected to the RAN, e.g., via an access and mobility management function (AMF) that is connected to the LMF 106 via an NLs interface.

In some embodiments, a positioning protocol A (e.g., NRPPa) is used to carry the positioning information between the RAN 104 and the LMF 106 over a next generation control plane interface (NG-C). The LMF 106 uses an LTE positioning protocol (LPP) via the AMF to configure the user device 102. The LPP is terminated between a target device (e.g., the user device 102) and a positioning server (e.g., the LMF 106). It may use either the control- or user-plane protocols as underlying transport.

In some embodiments, the wireless communication system 100 may include a hybrid positioning system. As described in more detail below, a hybrid positioning system uses positioning data (e.g., positioning estimates) from a plurality of positioning methods to calculate a user device position (also referred to as a “hybrid position” or a “hybrid position estimate).

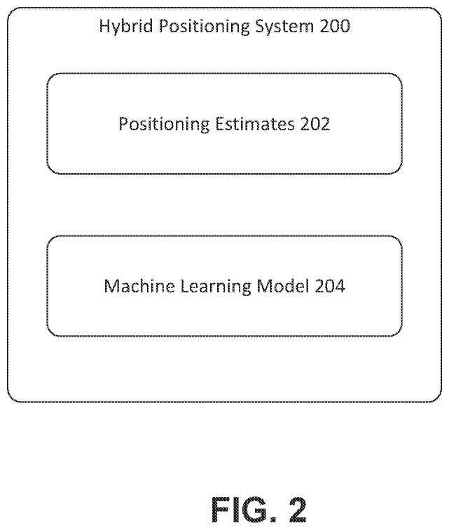

FIG. 2 illustrates an example hybrid positioning system 200, according to some implementations. The hybrid positioning system 200 can be implemented by a user device, a network (e.g., network device), or both a user device and network (e.g., some functionalities of the system are implemented on the user device and other functionalities are implemented on the network).

In some embodiments, the hybrid positioning system 200 obtains positioning information for the user device from a plurality of positioning methods. The hybrid positioning system 200 then stores the positioning information as positioning data 202. The positioning data 202 can include positioning estimates calculated using a plurality of positioning methods. The plurality of positioning methods can be executed by the user device and/or another device (e.g., a network device). Within examples, the plurality of positioning methods can include one or more of RAT-dependent positioning methods, such as enhanced Cell ID (E-CellID), multi-cell round trip time (Multi-RTT), downlink angle-of-departure (DL-AoD), downlink time difference of arrival (DL-TDOA), uplink time difference of arrival (UL-TDOA), uplink angle-of-arrival (UL-AOA). Additionally and/or alternatively, the plurality of positioning methods can include one or more of RAT-independent positioning methods, such as global navigation satellite system (GNSS), wireless local area network (WLAN) methods, Bluetooth (BT) methods, Terrestrial Beacon System (TBS).

In some embodiments, the hybrid positioning system 200 calculates hybrid positioning data for the user device based on the positioning data 202. In one example, the hybrid positioning system 200 calculates the hybrid positioning data by calculating a weighted average of the positioning data 202. Specifically, the hybrid positioning system 200 applies different weight factors to the different positioning estimates to calculate the final “hybrid” positioning estimate.

In some embodiments, the hybrid positioning system 200 uses one or more machine learning algorithms to train the machine learning model. In some examples, the hybrid positioning system 200 includes a trained machine learning model 204. The machine learning model 204 produces the location estimate based on one or more inputs. The input to the machine learning model include positioning estimates produced by one or more positioning methods supported by the UE or the network (e.g., LMF). Additionally and/or alternatively, the inputs can include a device coarse location (e.g., cell ID, tracking area (TA), etc.), current time, and/or whether the device is indoor/outdoor (e.g., binary indication). The output of the machine learning model is the hybrid positioning estimate.

In some embodiments, the training involves comparing the output of the machine learning model 204 to reference location information (e.g., information obtained using other positioning methods, e.g., GNSS). The comparison to the reference location can be used for, for example, NN back propagation training. The training phase can be performed by the hybrid positioning system 200 (e.g., at the user device or at the network) and/or another system (e.g., a designated training system). The one or more nodes at which the training phase is implemented is referred to as a training node. The machine learning model 204 can be used in the same device it was trained in (e.g. LMF or UE) or sent to another device (LMF or UE). The one or more nodes that use the machine learning model 204 is referred to as an inference node.

In some embodiments, the machine learning model 204 can be trained using machine-learning algorithms, such as supervised learning. In supervised learning, inputs and corresponding outputs of interest are provided to the machine learning model 204. The machine learning model 204 adjusts its functions (e.g., in the case of a neural network, one or more weights associated with two or more nodes of two or more different layers) based on a comparison of the output of the machine learning model 204 and an expected output in order to provide the desired output when subsequent inputs are provided. Examples of supervised learning algorithms include deep neural networks, similarity learning, linear regression, random forests, k-nearest neighbors, support vector machines, and decision trees.

In some embodiments, during an inference phase, which can be performed at the user device or the network (e.g., LMF), more than one positioning methods are used, their outputs are fed into the trained ML model, which generates the hybrid positioning estimate.

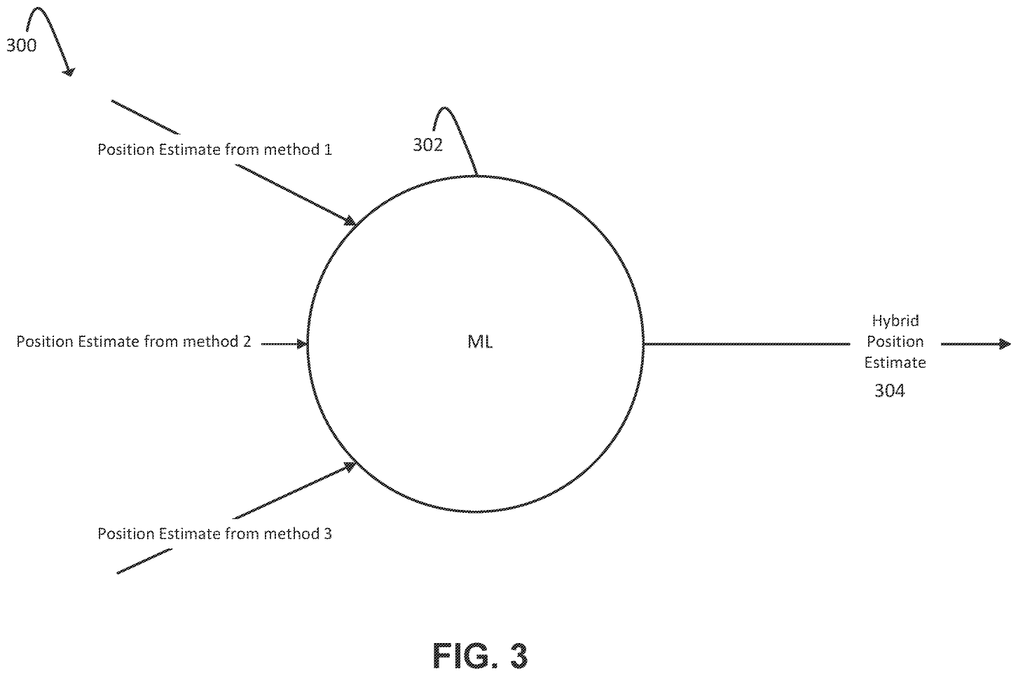

FIG. 3 illustrates an example hybrid positioning workflow 300, according to some implementations. The hybrid positioning workflow 300 can be implemented during an inference phase by a user device and/or a network (e.g., an LMF). As shown in FIG. 3, position estimates from a plurality of positioning methods are fed into a machine learning model 302. In the example of FIG. 3, three position estimates from three positioning methods are input to the machine learning model 302. However, in other examples, any plurality of position estimates may be used as input. Additionally, other information, such as a device coarse location, current time, and/or whether the device is indoor/outdoor, may also be input to the machine learning model 302. As also shown in FIG. 3, the output from the machine learning model 302 is a hybrid position estimate 304. As explained previously, the hybrid position estimate 304 may be a weighted sum of the input position estimates, where the weights are determined by the machine learning model 302.

In some embodiments, signaling enhancements are implemented for the user device and/or the network in order to support the hybrid positioning system 200. In one example, enhancements are made to the signaling between the user device and the network in order to support requesting and receiving a hybrid positioning estimate. As an example, in the implementation where the user device calculates the hybrid positioning estimate, an LPP RequestLocationInformation message from the network to the user device is modified to enable the network (e.g., the LMF) to request hybrid positioning estimates from the user device. Additionally, an LPP ProvideLocationInformation message from the user device to the network is modified to provide hybrid positioning results.

In some embodiments, to enable training in one node (e.g., the user device or the network) and inference in another node (the other one of the user device or the network), a positioning protocol is enhanced to support model transfer. As an example, in the implementation where model training is done by the network, an LPP RequestAssistanceData message from the user device to the network is modified to enable the user device to request a hybrid positioning ML model (e.g., machine learning model 204). The RequestAssistanceData message may trigger the ML training phase or the ML training may be performed before the request. Additionally, LPP ProvideAssistanceData (network to the user device) is modified to provide a hybrid positioning ML model.

In some embodiments, a new LPP procedure can be defined to transfer the trained ML model from the user device to the network (if the model training is performed by the user device). The new LPP procedure can include an LPP message RequestUEAssistanceData from the network to the user device. Additionally, the new LPP procedure can include an LPP message ProvideUEAssistanceData from the user device to the network.

In some embodiments, the machine learning model may be continuously or periodically updated as the training node obtains more training data points. In order to determine the version of the machine learning model that is currently being used, each iteration of the machine learning model may be assigned a version identifier. An inference node may use the version identifier in a request for a machine learning model from the training node. If the inference node already has the newest version of the machine learning model, the training node may inform the inference node as such. The signaling described herein may include a field that includes the version identifier.

In some embodiments, the wireless communication system 100 may additionally and/or alternatively include a UE-based fingerprinting positioning system. Fingerprinting positioning is a technique of developing a radio frequency (RF) map of particular areas of a location or environment based on predetermined received signal strength indicators (RSSI) values emanating, for example, from a Wi-Fi connected device or other wireless connectivity “hotspots.” Currently, fingerprinting may be implemented by a network. Because fingerprinting is implemented network side, the positioning system may suffer from latency issues and may not be available to a user device that is out of coverage. The advantages of a user device-based fingerprinting positioning system is at least lower latency and out-of-coverage positioning.

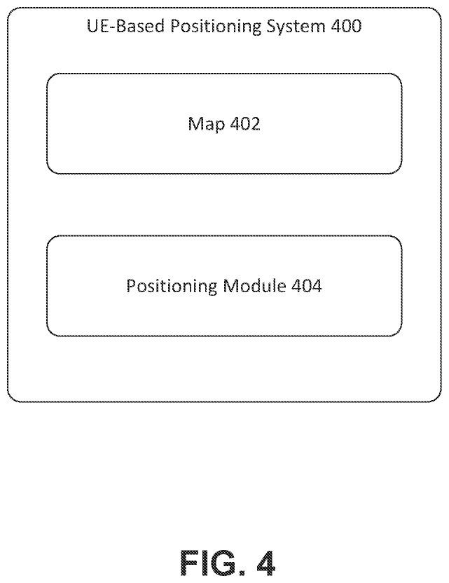

FIG. 4 illustrates a user device-based (UE-based) fingerprinting positioning system 400, according to some implementations. The UE-based fingerprinting positioning system 400 can be implemented by a user device.

In some embodiments, the user device receives a map of RF measurements. The map may be generated by the user device or another device (e.g., a network device or another user device). The map may be of particular areas of a location or environment based on predetermined received signal strength indicators (RSSI) values. The map is stored in the user device as map 402.

In some embodiments, a positioning module 404 uses the map 402 to determine a position of the user device. The positioning module 404 uses signal strength indicator values (e.g., RSSI) of the user device to the network. The values are then compared to the map (e.g. using K-nearest neighbor (KNN) algorithm) to find a best match. The k-nearest fingerprints are found in the map 402 by using, for example, the Euclidean distance between the measured RSSI and the referred one from the map 402. The positioning estimate is then calculated based on these k-nearest fingerprints, e.g. by averaging their reference point locations.

In some embodiments, signaling enhancements are implemented for the user device and/or the network in order to support the UE-based fingerprinting positioning system 400. In an example, the signaling enhancement defines a way to transfer the map to the user device. This can be realized by: (i) enhancing existing LPP messages: RequestAssistanceData (user device to network) and ProvideAssistanceData (network to user device), (ii) or by new LPP messages: RequestMapInformation (user device to network) and ProvideMapInformation (network to user device). The messages can be used to transfer the whole map, or a portion of the map available at the network. In the latter case, the request from the user device may carry a coarse user device location. Alternatively, the network may estimate the coarse user device location, e.g., based on the TA or cell id of the user device.

In some embodiments, new user device capabilities may be implemented in order to support the systems described herein. The new user device capabilities include support for hybrid positioning and/or support for UE-based fingerprinting positioning. Additionally, the capability to provide the ML model for hybrid positioning may be introduced. To support these new capabilities the following LPP messages are enhanced: RequestCapabilities (for the network to request user device capabilities) and ProvideCapabilities (for the user device to provide capabilities to the network).

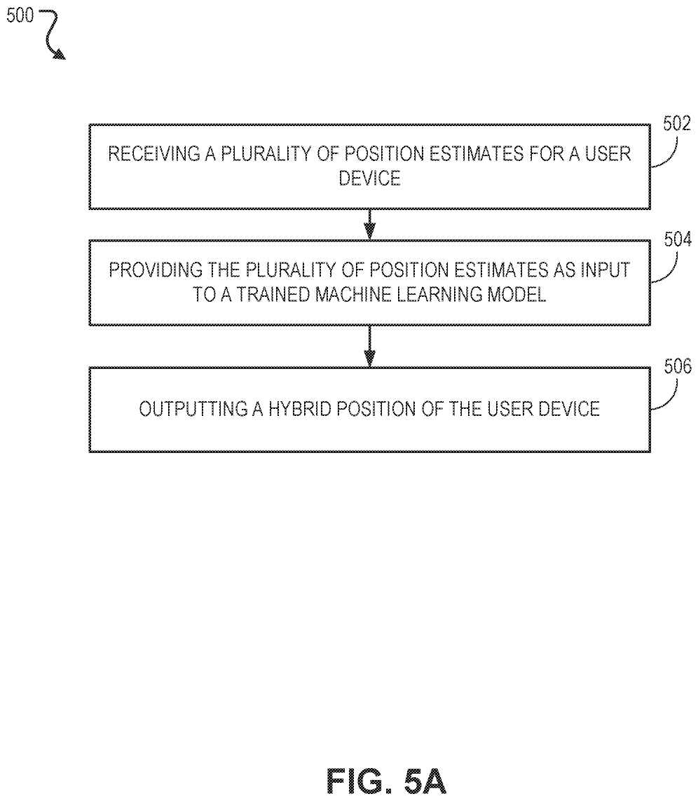

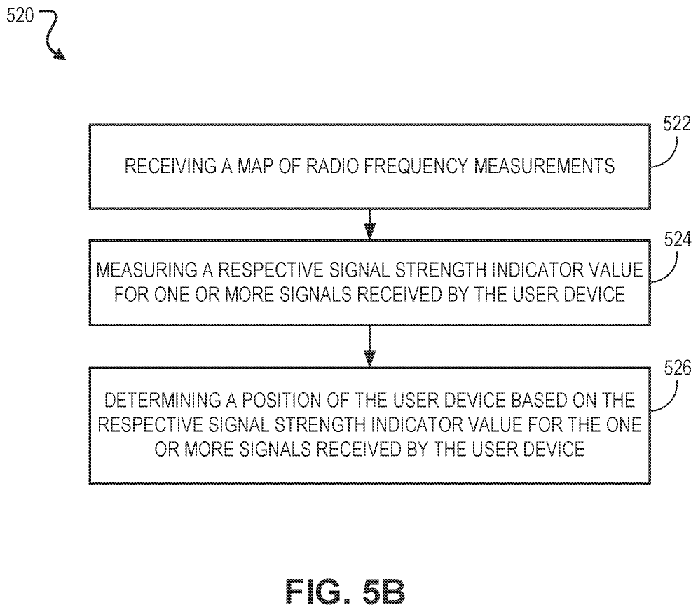

FIG. 5A illustrates a hybrid positioning method 500, according to some implementations. For clarity of presentation, the description that follows generally describes method 500 in the context of the other figures in this description. For example, method 500 can be performed by a network entity, e.g., LMF 106 or by a user device, e.g., user device 102. However, it will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At step 502, the method 500 involves receiving a plurality of position estimates for a user device. The plurality of position estimates may be generated from a plurality of positioning methods.

At step 504, the method 500 involves providing the plurality of position estimates as input to a trained machine learning model.

At step 506, the method 500 involves outputting a hybrid position of the user device. In some implementations hybrid position is a weighted average of the plurality of position estimates.

In some implementations, the machine learning model is trained using a machine learning algorithm. In some implementations, the machine learning algorithm is a supervised learning algorithm.

In some implementations, the machine learning training involves comparing an output of the machine learning model to reference location information. In some implementations, the reference location information is known location information.

In some implementations, the method 500 is executed by the user device.

In some implementations, the method 500 is executed by a network entity.

In some implementations, the network entity is an LMF.

In some implementations, the method 500 further involving: receiving a first message from a network entity requesting the hybrid position, and generating a second message to communicate the hybrid position to the network entity.

In some implementations, the first message is a RequestLocationInformation message from the network, and the second message is a LPP ProvideLocationInformation message.

In some implementations, the method 500 further involving: generating a request for the machine learning model; communicating the request in a first message to a training node; and receiving the machine learning model in a second message from the training node.

In some implementations, the first message is a LPP RequestAssistanceData message and the second message is a LPP ProvideAssistanceData message.

In some implementations, the first message is an LPP message RequestUEAssistanceData and the second message is an LPP ProvideUEAssistanceData message.

FIG. 5B illustrates a UE-based fingerprinting positioning method 520, according to some implementations. For clarity of presentation, the description that follows generally describes method 520 in the context of the other figures in this description. For example, method 520 can be performed by a user device, e.g., user device 102. However, it will be understood that method 520 can be performed, for example, by any suitable system, environment, software, hardware, or a combination of systems, environments, software, and hardware, as appropriate. In some implementations, various steps of method 520 can be run in parallel, in combination, in loops, or in any order

At step 522, the method 500 involves receiving a map of radio frequency measurements. The map may be generated by the user device or another device (e.g., a network device). The map may be of particular areas of a location or environment based on predetermined received signal strength indicators (RSSI) values.

At step 524, the method 500 involves measuring a respective signal strength indicator value for one or more signals received by the user device. In some implementations, the values are compared to the map (e.g. using K-nearest neighbor (KNN) algorithm) to find a best match. The k-nearest fingerprints are found in the map by using a Euclidean distance between the measured values and the referred one from the map. The positioning estimate is then calculated based on these k-nearest fingerprints by averaging their reference point locations. In some examples, the value of k is determined through an iterative process (e.g., trial and error).

At step 526, the method 500 involves determining a position of the user device based on the respective signal strength indicator value for the one or more signals received by the user device

In some implementations, using the map to determine the position of the user device involves: comparing the respective signal strength indicator value to the map; and identifying k-nearest matches to the respective signal strength indicator value.

In some implementations, the comparison is performed using a K-nearest neighbor (KNN) algorithm.

In some implementations, identifying the k-nearest matches involves using a Euclidean distance between the respective signal strength indicator value and one or more reference values in the map.

In some implementations, the method 520 further involves calculating the position based on the k-nearest fingerprints.

In some implementations, calculating the position based on the k-nearest fingerprints involves averaging positions associated with the k-nearest matches.

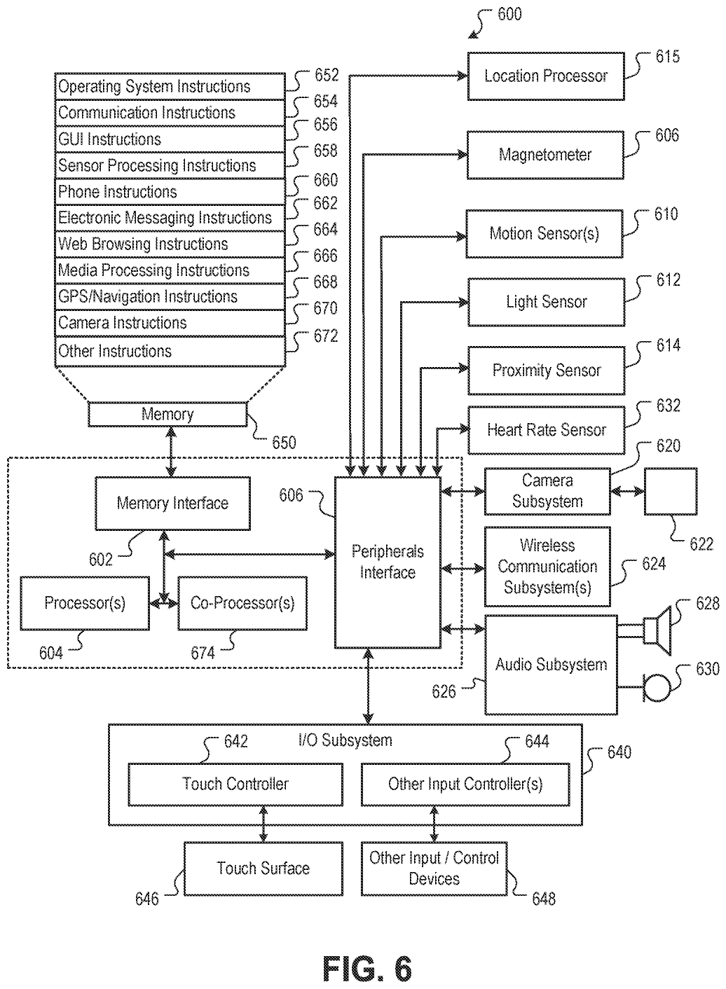

FIG. 6 is a block diagram of an example device architecture 600 for implementing the features and processes described in reference to FIGS. 1-5B. For example, the architecture 600 can be used to implement the user device 102 and/or the LMF 106. Architecture 600 may be implemented in any device for generating the features described in reference to FIGS. 1-5B, including but not limited to desktop computers, server computers, portable computers, smart phones, tablet computers, game consoles, wearable computers, set top boxes, media players, smart TVs, and the like.

The architecture 600 can include a memory interface 602, one or more data processor 604, one or more data co-processors 674, and a peripherals interface 606. The memory interface 602, the processor(s) 604, the co-processor(s) 674, and/or the peripherals interface 606 can be separate components or can be integrated in one or more integrated circuits. One or more communication buses or signal lines may couple the various components.

The processor(s) 604 and/or the co-processor(s) 674 can operate in conjunction to perform the operations described herein. For instance, the processor(s) 604 can include one or more central processing units (CPUs) that are configured to function as the primary computer processors for the architecture 600. As an example, the processor(s) 604 can be configured to perform generalized data processing tasks of the architecture 600. Further, at least some of the data processing tasks can be offloaded to the co-processor(s) 674. For example, specialized data processing tasks, such as processing motion data, processing image data, encrypting data, and/or performing certain types of arithmetic operations, can be offloaded to one or more specialized co-processor(s) 674 for handling those tasks. In some cases, the processor(s) 604 can be relatively more powerful than the co-processor(s) 674 and/or can consume more power than the co-processor(s) 674. This can be useful, for example, as it enables the processor(s) 604 to handle generalized tasks quickly, while also offloading certain other tasks to co-processor(s) 674 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 604 for further analysis.

Sensors, devices, and subsystems can be coupled to peripherals interface 606 to facilitate multiple functionalities. For example, a motion sensor 610, a light sensor 612, and a proximity sensor 614 can be coupled to the peripherals interface 606 to facilitate orientation, lighting, and proximity functions of the architecture 600. For example, in some implementations, a light sensor 612 can be utilized to facilitate adjusting the brightness of a touch surface 646. In some implementations, a motion sensor 610 can be utilized to detect movement and orientation of the device. For example, the motion sensor 610 can include one or more accelerometers (e.g., to measure the acceleration experienced by the motion sensor 610 and/or the architecture 600 over a period of time), and/or one or more compasses or gyros (e.g., to measure the orientation of the motion sensor 610 and/or the mobile device). In some cases, the measurement information obtained by the motion sensor 610 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 610 can be directly integrated into a co-processor 674 configured to processes measurements obtained by the motion sensor 610. For example, a co-processor 674 can include one more accelerometers, compasses, and/or gyroscopes, and can be configured to obtain sensor data from each of these sensors, process the sensor data, and transmit the processed data to the processor(s) 604 for further analysis.

Other sensors may also be connected to the peripherals interface 606, such as a temperature sensor, a biometric sensor, or other sensing device, to facilitate related functionalities. As an example, as shown in FIG. 6, the architecture 600 can include a heart rate sensor 632 that measures the beats of a user's heart. Similarly, these other sensors also can be directly integrated into one or more co-processor(s) 674 configured to process measurements obtained from those sensors.

A location processor 615 (e.g., a GNSS receiver chip) can be connected to the peripherals interface 606 to provide geo-referencing. An electronic magnetometer 616 (e.g., an integrated circuit chip) can also be connected to the peripherals interface 606 to provide data that may be used to determine the direction of magnetic North. Thus, the electronic magnetometer 616 can be used as an electronic compass.

A camera subsystem 620 and an optical sensor 622 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 624. The communication subsystem(s) 624 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 624 can depend on the communication network(s) or medium(s) over which the architecture 600 is intended to operate. For example, the architecture 600 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 600 can be configured as a base station for other wireless devices. As another example, the communication subsystems 624 may allow the architecture 600 to synchronize with a host device using one or more protocols, such as, for example, the TCP/IP protocol, HTTP protocol, UDP protocol, and any other known protocol.

An audio subsystem 626 can be coupled to a speaker 628 and one or more microphones 630 to facilitate voice-enabled functions, such as voice recognition, voice replication, digital recording, and telephony functions.

An I/O subsystem 640 can include a touch controller 642 and/or other input controller(s) 644. The touch controller 642 can be coupled to a touch surface 646. The touch surface 646 and the touch controller 642 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 646. In one implementations, the touch surface 646 can display virtual or soft buttons and a virtual keyboard, which can be used as an input/output device by the user.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

In some implementations, the architecture 600 can present recorded audio and/or video files, such as MP3, AAC, and MPEG video files. In some implementations, the architecture 600 can include the functionality of an MP3 player and may include a pin connector for tethering to other devices. Other input/output and control devices may be used.

A memory interface 602 can be coupled to a memory 650. The memory 650 can include high-speed random access memory or non-volatile memory, such as one or more magnetic disk storage devices, one or more optical storage devices, or flash memory (e.g., NAND, NOR). The memory 650 can store an operating system 652, such as Darwin, RTXC, LINUX, UNIX, OS X, WINDOWS, ANDROID, or an embedded operating system such as VxWorks. The operating system 652 can include instructions for handling basic system services and for performing hardware dependent tasks. In some implementations, the operating system 652 can include a kernel (e.g., UNIX kernel).

The memory 650 can also store communication instructions 654 to facilitate communicating with one or more additional devices, one or more computers or servers, including peer-to-peer communications. The communication instructions 654 can also be used to select an operational mode or communication medium for use by the device, based on a geographic location (obtained by the GPS/Navigation instructions 668) of the device. The memory 650 can include graphical user interface instructions 656 to facilitate graphic user interface processing, including a touch model for interpreting touch inputs and gestures; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes; camera instructions 670 to facilitate camera-related processes and functions; and other instructions 672 for performing some or all of the processes described herein.

Each of the above identified instructions and applications can correspond to a set of instructions for performing one or more functions described herein. These instructions need not be implemented as separate software programs, procedures, or modules. The memory 650 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device for displaying information to the author and a keyboard and a pointing device such as a mouse or a trackball by which the author may provide input to the computer.

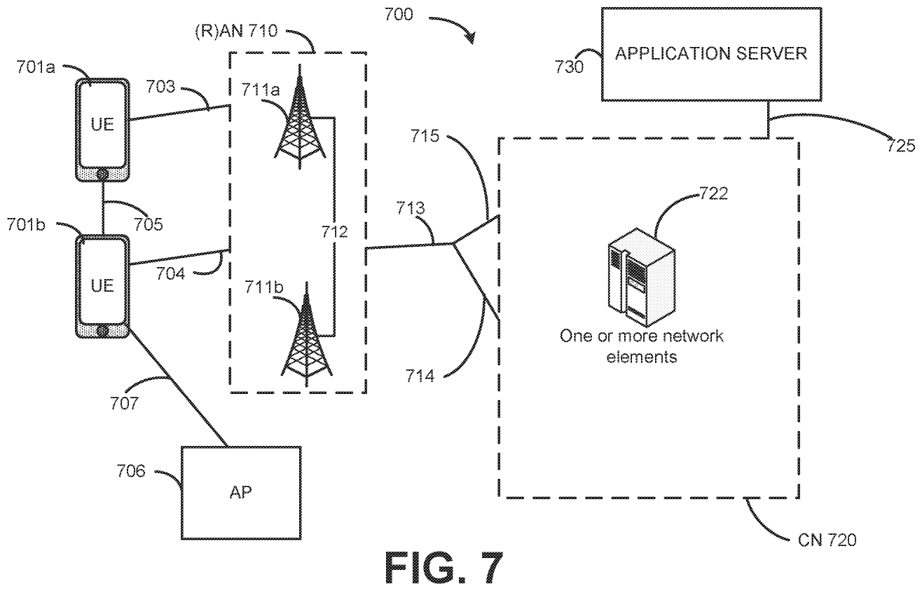

FIG. 7 illustrates an example of a wireless communication system 700, according to some implementations. For purposes of convenience and without limitation, the example system 100 is described in the context of Long Term Evolution (LTE) and Fifth Generation (5G) New Radio (NR) communication standards as defined by the Third Generation Partnership Project (3GPP) technical specifications. More specifically, the wireless communication system 700 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 700 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like.

As shown by FIG. 7, the system 700 includes UE 701a and UE 701b (collectively referred to as “UEs 701” or “UE 701”). In this example, UEs 701 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or“smart” appliances, MTC devices, M2M, IoT devices, and/or the like. The UEs 701 may be the same as or similar to user device 102.

The UEs 701 may be configured to connect, for example, communicatively couple, with RAN 710. In embodiments, the RAN 710 may be an NG RAN or a 5G RAN, an E-UTRAN, or a legacy RAN, such as a UTRAN or GERAN. As used herein, the term “NG RAN” or the like may refer to a RAN 710 that operates in an NR or 5G system 700, and the term “E-UTRAN” or the like may refer to a RAN 710 that operates in an LTE or 4G system 700. The UEs 701 utilize connections (or channels) 703 and 704, respectively, each of which comprises a physical communications interface or layer (discussed in further detail below). The RAN 710 may be the same as or similar to RAN 104.

In this example, the connections 703 and 704 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UEs 701 may directly exchange communication data via a ProSe interface 705. The ProSe interface 705 may alternatively be referred to as a SL interface 705 and may comprise one or more logical channels, including but not limited to a PSCCH, a PSSCH, a PSDCH, and a PSBCH.

The UE 701b is shown to be configured to access an AP 706 (also referred to as “WLAN node 706,” “WLAN 706,” “WLAN Termination 706,” “WT 706” or the like) via connection 707. The connection 707 can comprise a local wireless connection, such as a connection consistent with any IEEE 802.11 protocol, wherein the AP 706 would comprise a wireless fidelity (Wi-Fi®) router. In this example, the AP 706 is shown to be connected to the Internet without connecting to the core network of the wireless system (described in further detail below). In various embodiments, the UE 701b, RAN 710, and AP 706 may be configured to utilize LWA operation and/or LWIP operation. The LWA operation may involve the UE 701b in RRC_CONNECTED being configured by a RAN node 711a-b to utilize radio resources of LTE and WLAN. LWIP operation may involve the UE 701b using WLAN radio resources (e.g., connection 707) via IPsec protocol tunneling to authenticate and encrypt packets (e.g., IP packets) sent over the connection 707. IPsec tunneling may include encapsulating the entirety of original IP packets and adding a new packet header, thereby protecting the original header of the IP packets.

The RAN 710 can include one or more AN nodes or RAN nodes 711a and 711b (collectively referred to as “RAN nodes 711” or “RAN node 711”) that enable the connections 703 and 704. The nodes 711a and 711b are configured to communicate via link 712. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 711 that operates in an NR or 5G system 700 (for example, a gNB), and the term “E-UTRAN node” or the like may refer to a RAN node 711 that operates in an LTE or 4G system 700 (e.g., an eNB). According to various embodiments, the RAN nodes 711 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 711 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 711; a MAC/PHY split wherein RRC, PDCP, RLC, and MAC layers are operated by the CRAN/vBBUP and the PHY layer is operated by individual RAN nodes 711; or a “lower PHY” split wherein RRC, PDCP, RLC, MAC layers and upper portions of the PHY layer are operated by the CRAN/vBBUP and lower portions of the PHY layer are operated by individual RAN nodes 711. This virtualized framework allows the freed-up processor cores of the RAN nodes 711 to perform other virtualized applications. In some implementations, an individual RAN node 711 may represent individual gNB-DUs that are connected to a gNB-CU via individual F1 interfaces (not shown by FIG. 7). In these implementations, the gNB-DUs may include one or more remote radio heads or RFEMs, and the gNB-CU may be operated by a server that is located in the RAN 710 (not shown) or by a server pool in a similar manner as the CRAN/vBBUP. Additionally or alternatively, one or more of the RAN nodes 711 may be next generation eNBs (ng-eNBs), which are RAN nodes that provide E-UTRA user plane and control plane protocol terminations toward the UEs 701, and are connected to a 5GC via an NG interface.

Any of the RAN nodes 711 can terminate the air interface protocol and can be the first point of contact for the UEs 701. In some embodiments, any of the RAN nodes 711 can fulfill various logical functions for the RAN 710 including, but not limited to, radio network controller (RNC) functions such as radio bearer management, uplink and downlink dynamic radio resource management and data packet scheduling, and mobility management.

In embodiments, the UEs 701 can be configured to communicate using OFDM communication signals with each other or with any of the RAN nodes 711 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

According to various embodiments, the UEs 701 and the RAN nodes 711 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band. NR in the unlicensed spectrum may be referred to as NR-U, and LTE in an unlicensed spectrum may be referred to as LTE-U, licensed assisted access (LAA), or MulteFire.

To operate in the unlicensed spectrum, the UEs 701 and the RAN nodes 711 may operate using LAA, eLAA, and/or feLAA mechanisms. In these implementations, the UEs 701 and the RAN nodes 711 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The RAN 710 is shown to be communicatively coupled to a core network—in this embodiment, core network (CN) 720. The CN 720 may comprise a plurality of network elements 722, which are configured to offer various data and telecommunications services to customers/subscribers (e.g., users of UEs 701) who are connected to the CN 720 via the RAN 710. The components of the CN 720 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 720 may be referred to as a network slice, and a logical instantiation of a portion of the CN 720 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 730 may be an element offering applications that use IP bearer resources with the core network (e.g., UMTS PS domain, LTE PS data services, etc.). The application server 730 can also be configured to support one or more communication services (e.g., VoIP sessions, PTT sessions, group communication sessions, social networking services, etc.) for the UEs 701 via the EPC 720. The application server 730 can also be configured to communicate with the CN 720 via link 725.

In embodiments, the CN 720 may be a 5GC (referred to as “5GC 720” or the like), and the RAN 710 may be connected with the CN 720 via an NG interface 713. In embodiments, the NG interface 713 may be split into two parts, an NG user plane (NG-U) interface 714, which carries traffic data between the RAN nodes 711 and a UPF, and the S1 control plane (NG-C) interface 715, which is a signaling interface between the RAN nodes 711 and AMFs.

In embodiments, the CN 720 may be a 5G CN (referred to as “5GC 720” or the like), while in other embodiments, the CN 720 may be an EPC). Where CN 720 is an EPC (referred to as “EPC 720” or the like), the RAN 710 may be connected with the CN 720 via an S1 interface 713. In embodiments, the S1 interface 713 may be split into two parts, an S1 user plane (S1-U) interface 714, which carries traffic data between the RAN nodes 711 and the S-GW, and the S1-MME interface 715, which is a signaling interface between the RAN nodes 711 and MMEs.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
receiving a plurality of position estimates for a user device;
providing the plurality of position estimates as input to a trained machine learning model; and
outputting a hybrid position of the user device.

2. The method of claim 1, wherein the hybrid position is a weighted average of the plurality of position estimates.

3. The method of claim 1, wherein the method is executed by the user device.

4. The method of claim 1, wherein the method is executed by a network entity.

5. The method of claim 4, wherein the network entity is a location management function (LMF).

6. The method of claim 1, further comprising:
receiving a first message from a network entity requesting the hybrid position; and
generating a second message to communicate the hybrid position to the network entity.

7. The method of claim 6, wherein the first message is an LPP RequestLocationInformation message, and the second message is an LPP ProvideLocationInformation message.

8. A method to be performed by a user device, the method comprising:
receiving a map of radio frequency measurements;
measuring a respective signal strength indicator value for one or more signals received by the user device; and
determining a position of the user device based on the respective signal strength indicator value for the one or more signals received by the user device.

9. The method of claim 8, wherein using the map to determine the position of the user device comprises:
comparing the respective signal strength indicator value to the map; and
identifying k-nearest matches to the respective signal strength indicator value.

10. The method of claim 9, wherein the comparison is performed using a k-nearest neighbor (KNN) algorithm.

11. The method of claim 10, wherein the identifying the k-nearest matches comprises:
using a Euclidean distance between the respective signal strength indicator value and one or more reference values in the map.

12. The method of claim 10, further comprising:
calculating the position based on k-nearest fingerprints.

13. The method of claim 12, wherein calculating the position based on the k-nearest fingerprints comprises:
averaging positions associated with k-nearest matches.

14-15. (canceled)

16. One or more processors configured to cause a user device to perform operations comprising:
receiving a map of radio frequency measurements;
measuring a respective signal strength indicator value for one or more signals received by the user device; and
determining a position of the user device based on the respective signal strength indicator value for the one or more signals received by the user device.

17. The one or more processors of claim 16, wherein using the map to determine the position of the user device comprises:
comparing the respective signal strength indicator value to the map; and
identifying k-nearest matches to the respective signal strength indicator value.

18. The one or more processors of claim 17, wherein the comparison is performed using a k-nearest neighbor (KNN) algorithm.

19. The one or more processors of claim 17, wherein the identifying the k-nearest matches comprises:
using a Euclidean distance between the respective signal strength indicator value and one or more reference values in the map.

20. The one or more processors of claim 17, further comprising:
calculating the position based on k-nearest fingerprints.

21. The one or more processors of claim 20, wherein calculating the position based on the k-nearest fingerprints comprises:
averaging positions associated with k-nearest matches.
